(19) United States
(12) Patent Application Publication
(10) Pub. No.: US 2004/0048598 A1
(43) Pub. Date: Mar. 11, 2004

(54) Onboard communications system for a recreational vehicle

(76) Inventor: Marc D. Gagnon, Austin (CA)

Correspondence Address: PILLSBURY WINTHROP, LLP, P.O. BOX 10500, MCLEAN, VA, 22102, US

(21) Appl. No.: 10/659,390

(22) Filed: Sep. 11, 2003

Related U.S. Application Data
(60) Provisional application No. 60/409,601, filed on Sep. 11, 2002.

(51) Int. Cl. H04Q 7/20

(52) U.S. Cl. 455/404.2; 455/427; 455/456.1

(57) ABSTRACT

A vehicle such as an ATV, snowmobile, or PWC has an onboard communications system that sends and/or receives wireless signals from an external communications system. The onboard communications system includes one or more of the following communications system components: a GPS system, an emergency distress system, a snowmobile orientation sensor, fuel tank fuel level/engine speed/battery sensors, a weather radio, a transceiver, an ignition control system, a and two-way voice communications system. Two or more of these communications system components may interact. For example, the emergency distress system selectively sends a distress signal that includes positional data from the GPS system. The external communications system may be the onboard communications system of a second vehicle, which allows a display on the second vehicle to display the relative locations of the two vehicles. A compact display may show information concerning the onboard communications system and operational characteristics of the recreational vehicle.

### BACKGROUND OF THE INVENTION

1. Field of the Invention

The present invention relates to communications systems for personal recreational vehicles such as personal watercraft (PWCs), all-terrain vehicles (ATVs), and snowmobiles.

2. Description of Related Art

Conventional recreational vehicles such as PWCs, ATVs, and snowmobiles typically do not include onboard communications systems.

It is known to place rudimentary communications systems in PWCs. For example, U.S. Pat. No. 6,125,782 discloses a PWC with an onboard global positioning system (GPS). While the GPS system receives signals from GPS satellites, the GPS system does not send any signal.

It is known to place communications systems like GMC's (General Motors Corporation's) On Star system in automobiles. It is also known to place GMC's On Star system onto an ATV.

### SUMMARY OF THE INVENTION

According to one aspect of embodiments of the present invention, a recreational vehicle such as an ATV, a PWC, or a snowmobile is provided with an improved onboard communications system.

Another aspect of embodiments of the present invention provides, in combination with a vehicle, a communications network that includes a wireless communications system having a receiver. The vehicle has a frame, a straddle-type seat supported on the frame, and an onboard communications system mounted to the frame. The onboard communications system has a global positioning system and a wireless transmitter operatively connected to the global positioning system. The global positioning system transmits location to the receiver of the wireless communications system.

The communications network may also include a second vehicle that has a second frame and a second onboard communications system mounted to the second frame. The second onboard communications system includes a second global positioning system, the wireless communications system, and a display operatively connected to the second global positioning system. The display plots the relative locations of the vehicle and second vehicle.

The vehicle and second vehicle may be ATVs, snowmobiles, PWCs, sport boats, watercraft, or any other type of land, air, or water vehicles.

An alternative aspect of embodiments of the present invention provides, in combination with a vehicle, a communications network that includes a wireless communications system with a receiver. The vehicle includes a frame, a straddle-type seat supported on the frame, and an onboard communications system mounted to the frame. The onboard communications system includes an emergency distress system and a wireless transmitter operatively connected to the emergency distress system to selectively transmit a distress signal to the receiver of the wireless communications system.

The emergency distress system may include a rider-activated distress switch. The emergency distress system transmits the distress signal to the receiver of the wireless communications system when the distress switch is activated.

The emergency distress system may include a vehicle orientation sensor. The emergency distress system transmits the distress signal to the receiver of the wireless communications system when the orientation sensor senses that the vehicle is overturned (or otherwise disposed in a non-operating position). Alternatively, the emergency distress system may transmit the distress signal when the vehicle is left unoperated for a predetermined period of time after the engine is not stopped in a proper manner.

The wireless communications system and the onboard communications system may have interacting, two-way, wireless, voice communications systems.

A further alternative aspect of embodiments of the present invention provides, in combination with a vehicle, a communications network that includes a wireless communications system that includes a receiver. The vehicle includes a frame, a straddle-type seat supported on the frame, and an onboard communications system mounted to the frame. The onboard communications system has at least one sensor that monitors at least one operational characteristic of the vehicle. The onboard communications system also has a wireless transmitter operatively connected to the at least one sensor to transmit operational data sensed by the at least one sensor to the receiver of the wireless communications system.

The at least one sensor may be a speed sensor that monitors a speed of the vehicle such that the wireless transmitter transmits a signal corresponding to the vehicle speed to the wireless communications system. The vehicle may have a battery and the at least one sensor may be a battery charge level detector.

The vehicle may include a fluid tank, and the at least one sensor may be a fluid level gauge that senses a fluid level in the fluid tank. The wireless transmitter transmits a signal corresponding to the fluid level to the receiver of the wireless communications system. The power plant may be an engine and the fluid may be fuel for the engine.

An alternative aspect of embodiments of the present invention provides, in combination with a vehicle, a communications network that includes a wireless communications system that includes a transmitter that selectively transmits a power-plant-on signal. The vehicle includes a frame, a power plant having an ON/OFF switch, a straddle-type seat supported on the frame, and an onboard communications system mounted to the frame. The onboard communications system has a switch controller operatively connected to the ON/OFF switch to control the ON/OFF switch, and a wireless receiver operatively connected to the switch controller to selectively position the ON/OFF switch in the on mode when the wireless receiver receives the power-plant-on signal. The ON/OFF switch may be key-activated but allow the switch controller to turn on the ON/OFF switch without a key.

A further alternative aspect of embodiments of the present invention provides a communications network that includes a wireless communications system having a transmitter that broadcasts a global positioning signal and a vehicle. The vehicle has a frame, a straddle-type seat supported on the frame, and an onboard communications system mounted to the frame. The onboard communications system includes a global positioning system, and an antenna operatively connected to the global positioning system. The antenna receives the global positioning signal and relays it to the global positioning system.

The vehicle may be a snowmobile. The antenna may be mounted onto the snowmobile's front fairing. Alternatively, the antenna may be mounted onto a rear fairing of the snowmobile. The antenna may also be mounted onto the snowmobile's windshield. The antenna may alternatively be mounted onto the snowmobile's helm assembly. The antenna may also be mounted onto the snowmobile's bumper.

The communications network may also include a second wireless communications system having a transmitter that broadcasts a weather information signal. The onboard communications system may further include a receiver that receives the weather information signal. The onboard communications system may further include a display operatively connected to the receiver and the global positioning system to display location data provided by the global positioning system and weather information received by the receiver. The global positioning system may generate a positional map that is displayed on the display. The weather information signal may include real-time weather map information. The display may overlay the real-time weather map on the positional map.

The onboard communications system may further include an operatively interconnected display, rider interface, and transceiver. The communications network may also include a second wireless communications system that includes a transceiver that is operatively connected to the internet such that the transceivers of the onboard communications and the second wireless communications system interact to provide the vehicle with wireless internet access that is displayed on the display.

The onboard communications system may be detachable from the vehicle and have its own power source.

Embodiments of the present invention are also directed to a vehicle that may be used as part of the above-described communications networks.

A further alternative aspect of embodiments of the present invention is directed toward a vehicle that includes a frame, a straddle-type seat supported on the frame, and at least one sensor that monitors at least one operational characteristic of the vehicle. The vehicle also has an onboard communications system mounted to the frame. The onboard communications system is constructed and arranged to receive a wireless signal. The vehicle also includes a display mounted to the frame. The display is operatively connected to the at least one sensor and to the onboard communications system and displays information associated with (a) the at least one operational characteristic monitored by the at least one sensor, and (b) the wireless signal.

The display may be a single liquid crystal display screen. A cross-sectional area of the viewable display may be less than 150 cm². The display may either selectively or simultaneously display the information associated with (a) the at least one operational characteristic monitored by the at least one sensor, and (b) the wireless signal.

The vehicle may be used in combination with a communications network that includes a wireless communications system having a transmitter that broadcasts a wireless signal.

The at least one sensor may include a thermometer such that the display shows the temperature measured by the thermometer. The at least one sensor may include a speed sensor that monitors a speed of the vehicle such that the display shows the speed of the vehicle. The at least one sensor may include a battery charge level detector that measures a charge level of the vehicle's battery such that the display shows the battery charge level. The at least one sensor may include a fluid level sensor that senses a fluid level in a fluid tank of the vehicle such that the display shows the fluid level in the fluid tank.

The onboard communications system may include a global positioning system that determines location information such that the display shows the location information. The onboard communications system further include a wireless receiver that is constructed and arranged to receive location data from a second onboard communications system of a second vehicle so that the display can show the location of the second vehicle relative to the vehicle.

The onboard communications system may include an emergency distress system operatively connected to a wireless transmitter to selectively broadcast a distress signal. The display may indicate when the distress signal is being broadcast.

A further aspect of embodiments of the present invention provides a vehicle that includes a frame, a straddle-type seat supported on the frame, at least one sensor that monitors at least one operational characteristic of the vehicle, and an onboard communications system mounted to the frame. The onboard communications system includes first and second stacked, operatively interconnected circuit boards, a global positioning system having a global positioning system chip mounted on one of the circuit boards, and an electronics chip associated with the at least one sensor, the electronics chip being mounted on to one of the circuit boards. The onboard communications system may also include a two-way voice communications system that includes a voice communications chip mounted on one of the circuit boards.

Additional and/or alternative objects, features, aspects, and advantages of the present invention will become apparent from the following description, the accompanying drawings, and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 illustrates an onboard communications system according to the present invention as incorporated into a snowmobile;

FIG. 2 is a block diagram of the communications system of FIG. 1;

FIG. 3 is a front view of a display portion of one embodiment of the communications system of FIG. 1;

FIG. 4 is a cross-sectional view of one embodiment of a display and electrical circuitry portion of the communications system of FIG. 1, taken along the line 4-4 in FIG. 3;

FIG. 5 illustrates two of the communications systems of FIG. 2 incorporated into two snowmobiles;

FIG. 6 illustrates the communications system of FIG. 2 incorporated into a PWC; and

FIG. 7 illustrates the communications system of FIG. 2 incorporated into an ATV.

### DETAILED DESCRIPTION

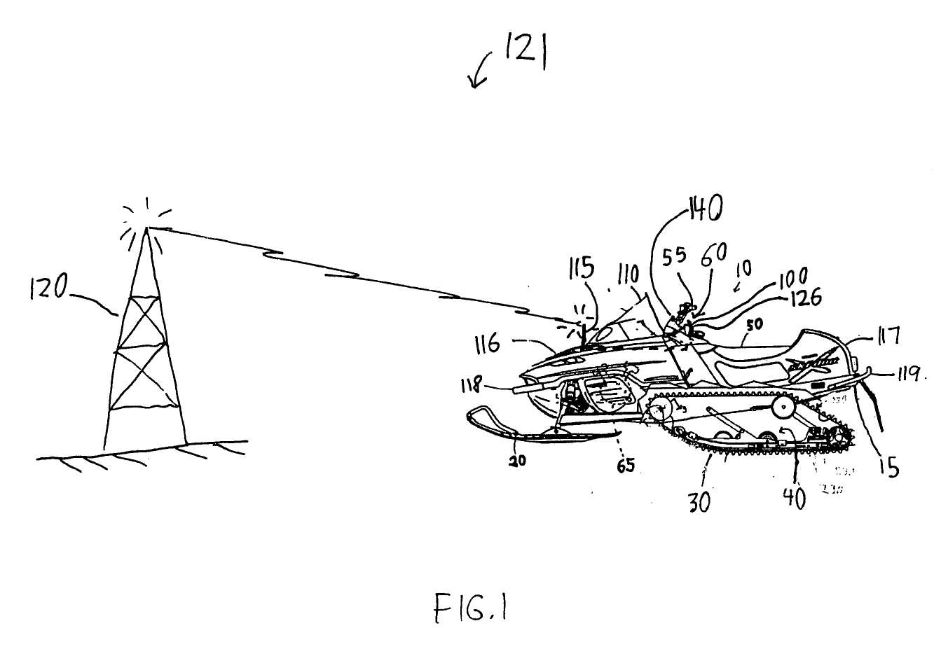

As illustrated in FIG. 1, a snowmobile 10 according to an embodiment of the present invention includes a frame 15 that supports a pair of selectively steerable skis 20. An endless track 30 is supported by the frame 15 through a slide rail suspension system 40. The frame 15 also supports a straddle-type seat 50. The selectively steerable skis 20 are operatively connected to handlebars 55 that are disposed on a helm assembly 60. The snowmobile 10 includes a power plant 65 (shown in phantom), such as an internal combustion engine, that is operatively connected to the endless track 30 to drive the snowmobile 10.

A communications system 100 is mounted to the helm assembly 60. The communications system 100 may alternatively be mounted to any other convenient location on the snowmobile 10. For example, the communications system 100 could alternatively be disposed between the helm assembly 60 and a windshield 110 of the snowmobile 10. As described in greater detail below, the communications system 100 may include any one or more of a variety of wireless communications tools that receive and/or send wireless signals.

The communications system includes an antenna 115 that receives and transmits signals. The antenna 115 may be positioned at any convenient location on the snowmobile 10, but is preferably disposed at a location the maximizes its sending and receiving power. As illustrated, the antenna 115 is mounted onto a front fairing 116 of the snowmobile 10. Alternatively, the antenna 115 may be mounted to the windshield 110, a display 126 of the communications system 100, the helm assembly 60, a rear fairing 117, a forward or rearward bumper 118, 119, respectively, etc.

While the antenna 115 is illustrated as a single antenna, the antenna 115 may alternatively comprise a plurality of antennae that are each specifically designed to transmit and/or receive specific types of wireless signals. For example, because different components of the communications system 100 transmit and/or receive wireless signals of varying frequency and/or amplitude, the antenna 115 may comprise a plurality of individual antennae, each one of which is specifically designed to be utilized by one or more of the components of the communications system 100. Each of the antennae making up the antenna 115 may be positioned in different places on the snowmobile 10 or may alternatively be disposed together in an antenna cluster.

The communications system 100 receives signals from and sends signals to an external communications system 120. While the illustrated external communications system 120 is an immovable, land-based transceiver, the external communications system 120 may alternatively comprise a variety of other types of communications systems without departing from the scope of the present invention. For example, the external communications system 120 may include global positioning satellites, land-based global positioning transmitters, radio stations, wireless receivers, other communications systems 100, cellular phone base stations, radio beacons, radio transceivers, etc. The communications system 100 and the external communications system 120 together form a communications network 121.

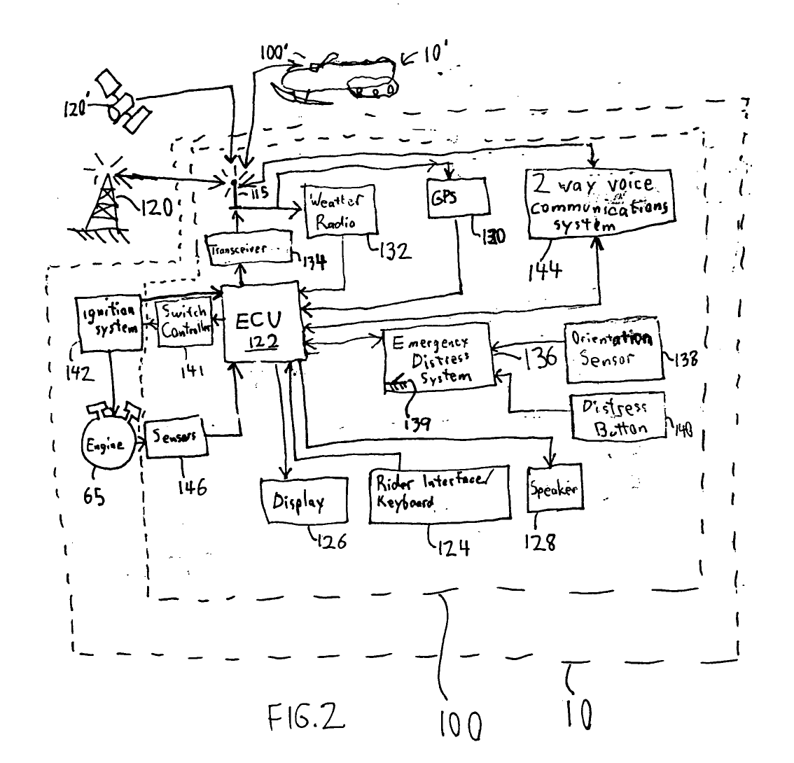

As schematically illustrated in FIG. 2, the communications system 100 has an electronic control unit (ECU) 122 that processes and responds to the information received from the various communications system 100 components. It is to be understood that the communications system 100 components could alternatively be stand-alone units that either include their own ECUs or do not require an ECU.

The communications system 100 also includes a user interface such as a keyboard or keypad 124. The rider of the snowmobile 10 may input various data into the keyboard 124 to control the ECU 122 of the communications system 100. Alternatively, the user interface 124 may include voice-actuation, foot operated controls, etc. Alternatively, the communications system 100 may operate totally independently of the rider of the snowmobile 10 and not include a user interface 124.

The ECU 122 transforms the received and processed data into a visual format on a display 126 (LCD (liquid crystal display) screen, digital display, etc.). The communications system 100 may alternatively include speakers 128 that audibly communicate signals to the rider of the snowmobile 10. Alternatively, the communications system 100 may relay information to the rider of the snowmobile 10 using any other method such as tactile (including, for example, a vibrate mode incorporated into the grips of the handle bars 55 or incorporated into the seat 50).

As described below, the communications system 100 preferably includes one or more communications system 100 components that receive wireless signals from the external communications system 120.

The communications system 100 includes a global positioning system (GPS) 130 that receives signals from global positioning satellites (and/or land-based global positioning transmitters, land-based radio-triangulation positioning systems, etc.) 120′ to determine the location of the snowmobile 10. The GPS system 130 may include real-time mapping that either creates a map as the snowmobile 10 travels or plots the position of the snowmobile 10 on a map that is stored in a local memory of the GPS system 130. Alternatively, the GPS system 130 may determine the latitude and longitude of the snowmobile 10.

The communications system 100 may include a weather radio 132. The communications system 100 may audibly broadcast weather advisories to the rider of the snowmobile 10 through the speakers 128 when the weather radio 132 receives such advisories from the external communications system 120. The weather radio 132 may also receive real-time digital weather information. For example, if the external communications system 120 sends real-time weather information or maps to the weather radio 132 of the communications system 100, the display 126 could overlay such weather maps or information on a map provided by the GPS system 130. This combination provides the rider of the snowmobile 10 with a real-time weather map of the surrounding area. Using these weather maps, the rider of the snowmobile 10 can avoid or prepare for severe weather before the severe weather reaches the snowmobile 10.

As described hereinafter, the communications system 100 also preferably includes one or more components that send signals to external communications systems 120 using a transceiver 134. The transceiver 134 may comprise a distinct transmitter and receiver or may alternatively be replaced by just a transmitter or just a receiver. The transceiver 134 may transmit and/or receive any type of conventional wireless signal(s) (e.g., FRS (family radio service), GSM (global system for mobile communication), cellular, GMRS (general mobile radio service), bluetooth, wi-fi (IEEE 802.11 standard), etc.).

The communications system 100 includes an emergency distress system 136 that may be automatically and/or manually activated. If the emergency distress system 136 is automatically activated, the communications system 100 sends out a distress signal using the transceiver 134 when the emergency distress system 136 senses that the snowmobile 10 has crashed, is inoperable, etc. The emergency distress system 136 includes an orientation sensor 138 such as a mercury switch that sends an overturned signal (or an inoperable position signal) to the ECU 122 when the switch is activated for more than a predetermined period of time. When the orientation sensor 138 signals to the ECU 122 that the snowmobile 10 is overturned (or is disposed in an inoperable position), the ECU 122 instructs the transceiver 134 to send out a distress signal. The emergency distress system 136 may also include a manually activated distress button 140 that is conveniently positioned on the snowmobile 10 (see FIG. 1). When the distress button 140 is activated by the rider of the snowmobile 10, the communications system 100 sends out a distress signal.

When a distress signal is sent out by the emergency distress system 136, the display 126 illustrates that the emergency distress system 136 is functioning and broadcasting an emergency signal. The display 126 may indicate the operation of the emergency distress system 136 in any of a variety of ways such as flashing a warning message (i.e., “DISTRESS SIGNAL BROADCASTING,” “EMERGENCY DISTRESS SYSTEM ACTIVATED,” etc.) or illuminating an LED or other indicator light that is next to an identifying text/graphic message. Alternatively, the emergency distress system 136 may audibly notify the rider of the activation of the emergency distress system 136 using the speakers 128. While a rider notification system is preferred, an emergency distress system 136 according to the present invention need not include a rider notification system.

The emergency distress system 136 also includes an ON/OFF switch 139. The ON/OFF switch may be rider actuated or may automatically turn on when the snowmobile 10 is turned on (e.g., when the power plant 65 is turned on by the ignition system 142, which is described in greater detail below). When the ON/OFF switch 139 is off, the emergency distress system 136 is deactivated and therefore incapable of sending out a distress signal. The ON/OFF switch 139 prevents false distress signals from being accidentally transmitted. The ON/OFF switch 139 may alternatively be automatically turned on only after the snowmobile 10 begins moving. The ON/OFF switch 139 may then automatically turn off after the snowmobile 10 has stopped for a predetermined period of time (e.g., 30 minutes, 1 hour, etc.). The display 126 may include an indicator light, text, graphic, etc. that notifies the rider when the emergency distress system 136 is on.

The distress signal sent by the communications system 100 may be generally broadcast or may be specifically sent to an external communications system 120 such as an emergency dispatch center. Upon receiving the distress signal, the emergency dispatch center can then send rescue/EMT (emergency medical technician) crews to the snowmobile 10. The communications system 100 may send location data from its GPS system 130 to the external communications system 120 so that the dispatch center knows where to send rescue crews. The emergency distress system 136, transceiver 134, and GPS system 130 may cooperate in a similar manner as Garmin's integrated GPS/FRS/GMRS Rino 110 radios, which transmit GPS location data to each other over FRS and GMRS frequencies. If the GPS system 130 maps the path of the snowmobile 10 during use, the communication system 100 may also send the external communications system 120 information that explains the path that the snowmobile 10 took to get to its present position. Such path information may help rescuers quickly and easily get to the snowmobile 10.

The communications system 100 also allows the external communications system 120 to selectively or continuously monitor various snowmobile 10 systems and/or the rider of the snowmobile 10. The external communications system 120 may request the communications system 100 to send location data to the external communications system 120 on command. Consequently, if the snowmobile 10 is stolen or lost, the owner of the snowmobile 10 may contact on operator of the external communications system 120 to find out where the lost snowmobile 10 is located. Alternatively, the communications system 100 may simply continuously send out location data even without a request from the external communications system 120.

The communications system 100 includes a switch controller 141 connected to an ON/OFF switch of an ignition/starter system 142 of the power plant 65 of the snowmobile 10. Accordingly, the external communications system 120 can remotely start and/or stop the power plant 65 of the snowmobile 10. Generally, the rider of the snowmobile 10 can only start the power plant 65 of the snowmobile 10 by using a key. If the rider of the snowmobile 10 loses his/her keys, the rider can call the operator of the external communications system 120 to have the external communications system 120 start the snowmobile 10 remotely without the key. Similarly, if the snowmobile 10 is lost or stolen, the external communications system 120 can remotely disable the snowmobile 10.

The communications system 100 also includes a cellular phone or other two-way voice communications system (such as a CB, GMRS, or FRS radios) 144 that allows the rider of the snowmobile 10 to communicate with the operator of the external communications system 120, which includes a corresponding two-way voice communications system. The display 126 may indicate the operational state of the communication system 144 (e.g., on, off, transmitting, receiving, etc.) via a light, an LED, a text message, a graphic, etc. The communications system 100 may also send positional data from the GPS system 130 to the external communications system 120 so that the dispatcher/operator of the external communications system 120 can provide the rider of the snowmobile 10 with real-time, continuous directions over the two-way voice communications system 144. Because snowmobiles are commonly used in wilderness areas with few landmarks or roads, the rider of the snowmobile 10 can use the real-time directions if he/she gets lost.

The communications system 100 is also operatively connected to various sensors 146 that monitor components of the snowmobile 10 such as the power plant 65, battery (not shown), fuel tank (not shown), fuel injectors, damage sensors, etc. The sensors 146 preferably include a fuel level sensor in the fuel tank of the snowmobile 10, a speedometer or tachometer of the snowmobile 10, and a battery sensor that senses a charge level of the battery of the snowmobile 10. The sensors 146 may monitor the speed of the snowmobile 10 by sensing any one of the following operational parameters: engine 65 speed, track 30 speed, etc. The sensors 146 may also monitor the fluid level of any other fluid tank in the snowmobile 10 (e.g., coolant tank, oil tank, etc.). The communications system 100 can then send such diagnostic information to the external communications system 120.

If the communications system 100 signals to the external communications system 120 that the fuel level in the fuel tank is low, an operator of the external communications system 120 can send a warning signal back to the snowmobile 10. For example, the operator of the external communications system 120 may use the two-way voice communications system 144 to ask the rider of the snowmobile 10 if he/she needs assistance. The operator of the external communications system 120 can even direct a third party to deliver fuel to the snowmobile 10.

Even absent external intervention, the communications system 100 directly notifies the rider when any of the sensed snowmobile 10 operational characteristics indicate a malfunction or other problem. The communications system 100 may notify the rider of such a problem visually on the display 126 (using, for example, a warning light, LED, text message, etc.), audibly using the speaker 128, or by using any other conventional notification system. The communications system 100 also operatively connects the sensors 146 to the display 126 such that the display 126 shows the sensed snowmobile 10 operational characteristics (e.g., snowmobile 10 speed, power plant 65 rotational speed, fuel level, battery level, etc.).

The emergency distress system 136 is also operatively connected to one or more of the sensors 146 and to the ignition system 142 such that the emergency distress system 136 and the ECU 122 automatically send out a distress signal if the ECU 122 and emergency distress system 136 determine that the power plant 65 of the snowmobile 10 has become inoperative. When operating normally, the power plant 65 may be shut off by shutting off the ignition system 142 (e.g., by removing a key, activating a kill switch, etc.). The ECU 122 monitors the ignition system 142 to determine whether the ignition system 142 has been switched off (e.g., by sensing whether a key has been removed, sensing whether the kill switch is activated, etc.). The ECU 122 also monitors a speed of the power plant 65 using the sensor 146 that monitors the speed of the power plant 65. When the ECU 122 determines that the power plant 65 has stopped but that the ignition system 142 has not been normally shut off, the ECU 122 waits for a predetermined period of time (e.g., 1 minute, 5 minutes, 15 minutes, etc.) to allow the rider to correct any problem with the power plant 65. If the predetermined period of time elapses without the power plant 65 being successfully restarted, the emergency distress system 136 transmits a distress signal.

The operator of the external communications system 120 may use the communications system 100 to track snowmobile 10 use in real time. For example, if the operator of the external communications system 120 rents snowmobiles 10, the operator can track where and how the rented snowmobiles 10 are being used in real time to ensure that the rented snowmobiles 10 are not being improperly used. For example, the operator may track the location, speed, etc. of the snowmobile 10 in real time as the communications system 100 sends signals from the sensors 146 to the external communications system 120 through the transceiver 134.

The communications system 100 may also be equipped with wireless internet access. Web information may be shown on the display 126. The communications system 100 may provide limited internet access (as on conventional internet-equipped cell phones and PDAs) or full, high-speed internet access (as on personal computers that are connected to high speed wireless networks). Such internet access may give the rider of the snowmobile 10 the ability to find real-time information about an almost infinitely large variety of topics. The rider of the snowmobile 10 may be able to make hotel, transportation, or restaurant reservations using the communication system 100. The internet access capability may be linked to the GPS system 130 so that the rider of the snowmobile 10 can quickly learn about restaurants, hotels, landmarks, attractions, etc. that are near the snowmobile 10.

The communications system 100 may also provide any of the features of conventional automotive communications systems (e.g., On-Star, RESCU, etc.). Such features may include emergency services, personal concierge services, roadside assistance, accident assistance, information services, virtual web-based information, online concierge, etc. The operator of the external communications system 120 may charge the rider of the snowmobile 10 a monthly or yearly fee for using the external communications system 120 in any of the above-identified ways.

While the communications system 100 has been described as included a plurality of components (e.g., a GPS system 130, an emergency distress system 136, a snowmobile 10 orientation sensor 134, fuel level/engine speed/battery sensors 146, a weather radio 132, a transceiver 134, an ignition control system, a two-way voice communications system 144, etc.), all of these communications system 100 components are not required to practice the present invention. Rather, a communications system according to the present invention may include just one of the communications system 100 components or any combination of two or more of the communications system 100 components.

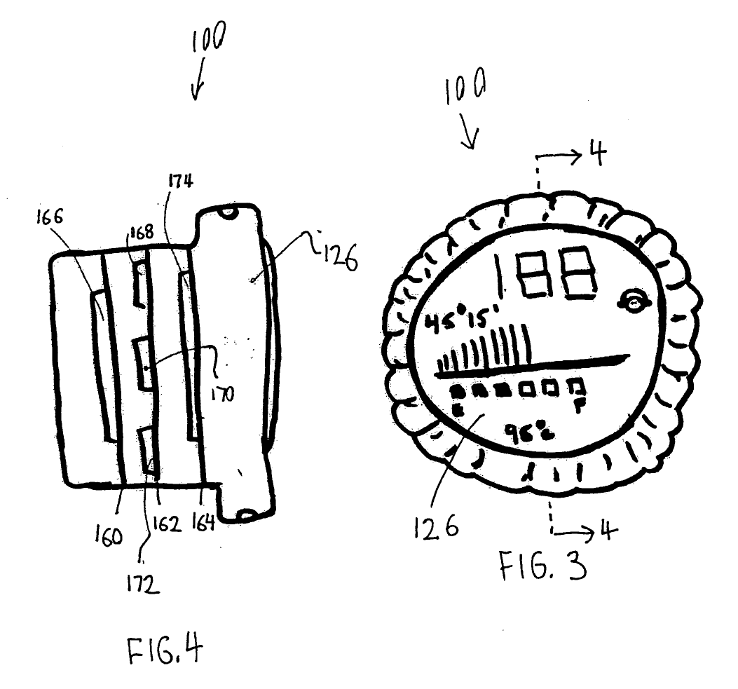

As illustrated in FIGS. 3 and 4, the components of the communications system 100 and the display 126 are mounted preferably adjacent to each other. The circuitry for the various components of the communications system 100 are mounted onto one of three stacked circuit boards 160, 162, 164. A variety of basic electronics chips 166 are disposed on the circuit board 160. The basic electronics chips 166 may include chips that control or receive signals from various electronic components of the snowmobile 10 (e.g., lights, speedometer, tachometer, ignition system 142, engine temperature gauge, electronic compass, display 126 controller chip, etc.). The circuit board 162 includes a bluetooth chip 168 for the transceiver 134, a GPS chip 170 for the GPS system 130, and an engine communications chip 172 for the sensors 146. The circuit board 164 includes a voice communications chip 174. While the illustrated communications system 100 includes three circuit boards 160, 162, 164, the communications system 100 could alternatively include greater or fewer circuit boards without deviating from the scope of the present invention. In fact, it is envisioned that a circuitboardless communications system 100 could also be used. The relative locations of the various chips could be altered without deviating from the scope of the present invention. Furthermore, additional chips could be added or existing chips could be omitted without deviating from the scope of the present invention. For example, an additional chip could monitor the number of hours that the snowmobile 10 is in use. A further chip could record and enable the display 126 to display the serial number of the snowmobile 10 or the software versions of various software components used in the snowmobile 10.

The display 126 is operatively connected to many or all of the communications system 100 components and snowmobile 10 gauge components so that the display 126 can selectively or simultaneously display information from these snowmobile 10 components. Because the most convenient display space (e.g., the available space around the helm assembly 60, windshield 110, handlebars 55, etc.) on recreational vehicles such as the snowmobile 10 is limited, the single display 126 can display a variety of information, thereby eliminating the need for multiple, space-consuming, displays. The display 126 preferably comprising a single display cluster that preferably includes a single LCD screen, but may alternatively include a plurality of distinct needle gauges, LCD screens, etc. As illustrated in FIG. 3, the display 126 is circular. However, the display 126 could also be rectangular to more easily accommodate one or more LCD screens. The viewable area of the display 126 is preferably less than 150 cm², but may alternatively be larger if space permits. To the extent that space permits on a vehicle, each communication system 100 component could have its own distinct display without departing from the scope of the present invention.

The three circuit boards 160, 162, 164 are stacked to conserve space. Because the instrument panel on the snowmobile 10 is small and somewhat cramped, many or all of the communications system 100 components and their associated display 126 are compactly fit together in the communications system 100 cluster shown in FIGS. 3 and 4. Alternatively, to the extent that space permits on a vehicle, each communication system 100 component could have its own distinct circuit board without departing from the scope of the present invention.

While the illustrated display 126 is mounted directly to the components of the communications system 100, the location of the display 126 is not limited to this location. Rather, the display 126 may be disposed at any convenient position on the snowmobile 10 without deviating from the scope of the present invention. Accordingly, the display 126 would be operatively connected to the components of the communications system 100 but be indirectly physically connected to the components of the communications system 100. For example, the display 126 may alternatively be disposed on the handlebars 55, on or near the windshield 110, etc.

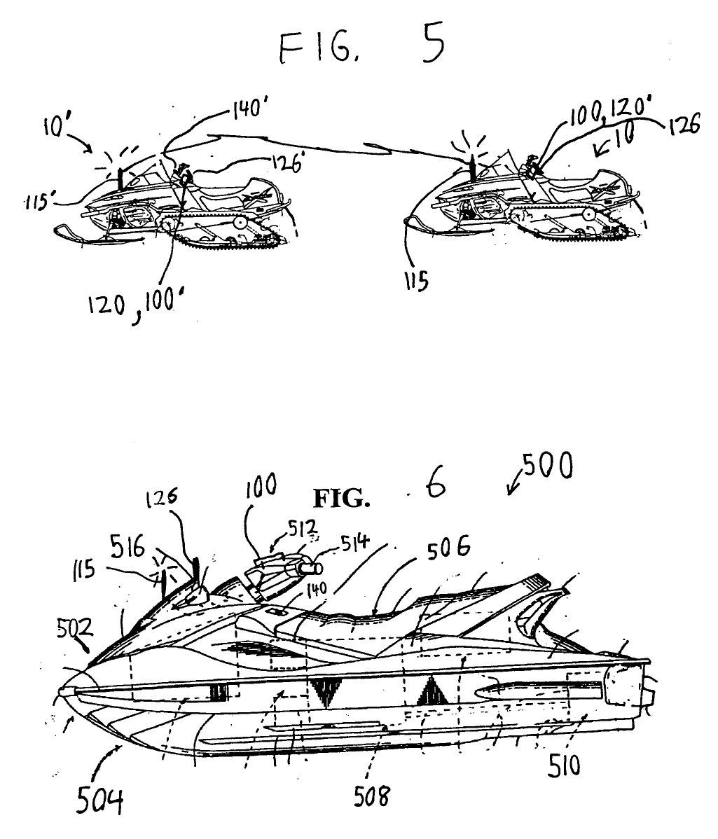

As illustrated in FIG. 5, the communications system 100 on the snowmobile 10 may also function as an external communications system 120′ for a second communications system 100′ on a second snowmobile 10′. Similarly, the communications system 100′ on the second snowmobile 10′ may function as the external communications system 120 for the communications system 100. Because the snowmobiles 10, 10′ are generally identical to each other, only the snowmobile 10 will be described in detail. It is to be understood that the description of the snowmobile 10 is equally applicable to the snowmobile 10′.

The communication systems 100, 100′ may send each other their respective location data from their GPS systems 130. Accordingly, the communications system 100 can display the relative position of the other snowmobile 10′ on its display 126. The relative positioning display makes it easy for the rider of the snowmobile 10 to find the snowmobile 10′. The communications system 100 may also receive distress signals from the emergency distress system 136 of the communications system 100′ and notify the rider of the snowmobile 10 that the other snowmobile 10′ or its rider are in distress.

While only two communications systems 100, 100′ are illustrated as interacting with each other, it is contemplated that numerous communications systems 100 could simultaneously interact with each other without departing from the scope of the present invention. For example, if every communications system 100 on every snowmobile 10 includes a GPS system 130, each communications system 100 could send location information to every other communications system 100 in its vicinity so that the relative positions of all other snowmobiles 10 are plotted on the displays 126 of each communication system 100.

The illustrated communications system 100 is rigidly mounted to the snowmobile 10 and is preferably powered by the battery (not shown) of the snowmobile 10. Alternatively, the communications system 100 could be detachable from the snowmobile 10 and include its own battery source. Accordingly, if the snowmobile 10 becomes inoperable, the rider of the snowmobile 10 can detach the communications system 100 and take it with him/her when the rider leaves the snowmobile 10. For example, if the snowmobile 10 becomes inoperable in a remote section of wilderness, the rider of the snowmobile 10 can take the communications system 100 with him/her to help guide the rider out of the wilderness while maintaining continuous communication with the operator of the external communications system 120.

While the communications system 100 has been described as an integral unit, the various components of the communications system may be discrete. Interrelated components may be operatively connected to each other despite being physically separated from each other.

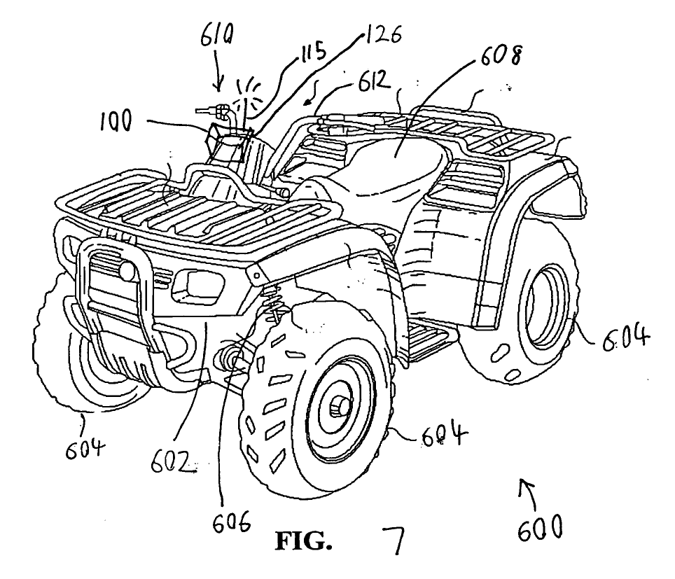

While the above-described communications system 100 is mounted to the snowmobile 10, the communications system 100 may alternatively be used on any of a variety of other vehicles. For example, as illustrated in FIG. 6, the communications system 100 may be mounted onto a PWC 500.

The PWC 500 includes a frame that is made of two main parts, a hull 504 and a deck 502 mounted on top of the hull 504. The hull 504 buoyantly supports the watercraft 500 in the water. The deck 502 includes a straddle-type seat 506 designed to accommodate a rider and, in some watercraft, one or more passengers. The PWC includes a propulsion system that includes a power plant 508 that is supported by the hull 504 and operatively connected to a propulsion unit 510. The power plant 504 is preferably an internal combustion engine but may alternatively comprise any other type of power plant (i.e., electric motor, hydraulic motor, etc.). The propulsion unit 510 is preferably a jet propulsion unit that has an impeller and a selectively steerable nozzle, but may alternatively comprise any other type of propulsion unit such as a propeller. The PWC 500 also includes a helm assembly 512 that includes a variety of displays and handlebars 514 that control the propulsion unit 510.

The communications system 100 is mounted onto the helm assembly 512. The display 126 of the controller is mounted onto a display panel 516 on the deck 502 of the PWC 500. The antenna 115 of the communications system 100 is mounted to the deck 502. While the communications system 100, antenna 115, and display 126 are positioned at specific locations on the PWC 500, the communications system 100, antenna 115, and display 126 may alternatively be mounted onto any other convenient portion of the PWC 500. For example, the communications system 100 and antenna 115 could be positioned within a cavity formed between the hull 504 and the deck 502. The display 126 could be disposed on the helm assembly 512.

If the GPS system 130 includes mapping capability, the PWC 500 rider can use the communications system 100 to guide the PWC 500 when the PWC 500 is far from shore or other landmarks, at night, or in severe weather (e.g., fog, storms, etc.). If additional watercraft (e.g., other PWCs, sport boats, yachts, zodiacs, sail boats, ships, etc.) are also equipped with a communications system 100, the communications systems 100 may interact so that the communications system 100 can plot the locations of nearby watercraft on the display 126. By plotting the positions of nearby watercraft, the communications system 100 may supplement or replace existing watercraft radar systems.

PWCs like the PWC 500 are often used in connection with larger yachts. The PWC 500 may be stored on the deck of a yacht and launched from the yacht. The yacht may also be equipped with a communications system 100 that enables interaction between the yacht and the PWC 500. For example, the communications system 100 may continuously display the real-time position of the yacht relative to the PWC 500 to easily guide the PWC 500 back to its home base yacht.

If the PWC 500 breaks down or encounters some other trouble, the communications system 100 on the PWC 500 may automatically send a distress signal that includes location data to the yacht so that the yacht can rescue the PWC 500 rider. The PWC 500 rider may alternatively activate the distress button 140 of the distress system 136 of the communications system 100 to send such a distress signal to the yacht. Alternatively, the communications system 100 of the PWC 500 may send a general distress signal to all other local watercraft that are equipped with a communications system 100. The communications system 100 may alternatively send a distress signal over open radio frequencies or even directly call emergency services (e.g., 911) using an onboard cellular phone or other two-way voice communications system 144 (see FIG. 2).

FIG. 7 illustrates an ATV 600 that is equipped with the communications system 100. The ATV 600 includes a frame 602 that supports four wheels 604 via a suspension system 606. The ATV 600 may alternatively include greater than or fewer than four wheels 604. A power plant (not shown) is operatively connected to at least one o the wheels 604 to drive the ATV 600. A straddle-type seat 608 is supported by the frame 602 and is designed to support an ATV 600 rider. A helm assembly 610 is disposed in front of the seat 608. The helm assembly includes handlebars 612 that are operatively connected to the front wheels 604 to steer the ATV 600. The communications system 100 is mounted onto the helm assembly 610. The display 126 and the antenna 115 of the communications system 100 are also preferably mounted onto the helm assembly 610. However, the communications system 100, display 126, and antenna 115 may alternatively be disposed on any other convenient location on the ATV 600 without departing from the scope of the present invention.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. A vehicle comprising:
a frame;
a straddle-type seat supported on the frame; and
an onboard communications system mounted to the frame, the onboard communications system comprising
a global positioning system, and
an antenna operatively connected to the global positioning system,
wherein the antenna receives a global positioning signal, which is relayed to the global positioning system.

2. The vehicle according to claim 1, wherein the vehicle comprises a snowmobile having a front fairing, and the antenna is mounted onto the front fairing.

3. The vehicle according to claim 1, wherein the vehicle comprises a snowmobile having a rear fairing, and the antenna is mounted onto the rear fairing.

4. The vehicle according to claim 1, wherein the vehicle comprises a snowmobile having a windshield, and the antenna is mounted onto the windshield.

5. The vehicle according to claim 1, wherein the vehicle comprises a snowmobile having a helm assembly, and the antenna is mounted onto the helm assembly.

6. The vehicle according to claim 1, wherein the vehicle comprises a snowmobile having a bumper, and the antenna is mounted onto the bumper.

7. The vehicle according to claim 1, wherein the onboard communications system further comprises a receiver that receives a weather information signal.

8. The vehicle according to claim 7, wherein the onboard communications system further comprises a display operatively connected to the receiver and the global positioning system to display location data provided by the global positioning system and weather information data associated with the weather information signal.

9. The vehicle according to claim 8, wherein the global positioning system generates a positional map that is displayed on the display, the weather information signal comprises real-time weather map information, and the display overlays the real-time weather map on the positional map.

10. The vehicle according to claim 1, wherein the onboard communications system further comprises a display, an interface, and a transceiver, and the transceiver is wirelessly connected to the internet to provide wireless internet access that is displayed on the display.

11. The vehicle according to claim 1, wherein the onboard communications system is detachable from the vehicle and further comprises a power source.
